(19) United States
(12) Patent Application Publication
(10) Pub. No.: US 2026/0059369 A1
(43) Pub. Date: Feb. 26, 2026

(54) TECHNOLOGIES FOR DIRECTLY DETERMINING MEASUREMENT OPPORTUNITY SHARING FOR LAYER ONE MEASUREMENTS

(71) Applicant: Apple Inc., Cupertino, CA (US)

(72) Inventors: Manasa Raghavan, Sunnyvale, CA (US); Qiming Li, Beijing (CN); Jie Cui, San Jose, CA (US); Yang Tang, San Jose, CA (US); Dawei Zhang, Saratoga, CA (US); Xiang Chen, Campbell, CA (US); Rolando E. Bettancourt Ortega, Munich (DE); Yuexia Song, Beijing (CN)

(73) Assignee: Apple Inc., Cupertino, CA (US)

(21) Appl. No.: 19/104,188

(22) PCT Filed: Aug. 16, 2022
(86) PCT No.: PCT/CN2022/112797

§ 371 Date: Feb. 14, 2025

(51) Int. Cl. H04W 24/10

(52) U.S. Cl. CPC H04W 24/10

(57) ABSTRACT

Presented are devices and components including apparatus, systems, and methods for sharing Layer 1 measurement opportunities in wireless networks.

### BACKGROUND

Third Generation Partnership Project (3GPP) defines a number of reference signals to facilitate communications in a wireless access cell. A base station may configure a user equipment (UE) to perform and report measurements on these reference signals in order to perform various beam and link management operations.

### BRIEF DESCRIPTION OF THE DRAWINGS

FIG. 1 illustrates a network environment, in accordance with some embodiments.

FIG. 2 illustrates a table for determining intermediate sharing factors in accordance with some embodiments.

FIG. 3 illustrates another table for determining intermediate sharing factors in accordance with some embodiments.

FIG. 4 illustrates example occasions in accordance with some embodiments.

FIG. 5 illustrates additional example occasions in accordance with some embodiments.

FIG. 6 illustrates a table for determining sharing factors in accordance with some embodiments.

FIG. 7 illustrates additional example occasions in accordance with some embodiments.

FIG. 8 illustrates additional example occasions in accordance with some embodiments.

FIG. 9 illustrates additional example occasions in accordance with some embodiments.

FIG. 10 illustrates additional example occasions in accordance with some embodiments.

FIG. 11 illustrates an operational flow/algorithmic structure in accordance with some embodiments.

FIG. 12 illustrates another operational flow/algorithmic structure, in accordance with some embodiments.

FIG. 13 illustrates another operational flow/algorithmic structure, in accordance with some embodiments.

FIG. 14 illustrates an user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

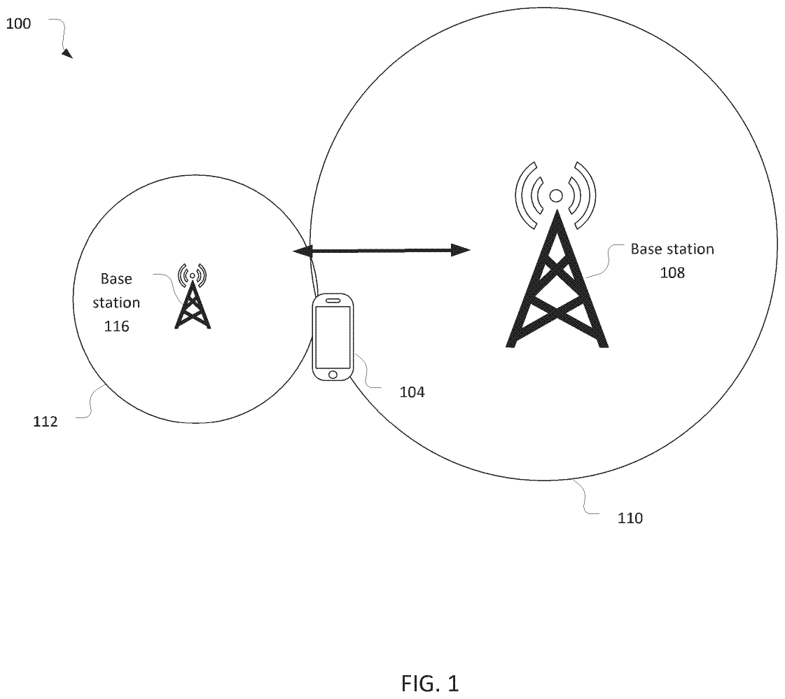

FIG. 1 illustrates a network environment 100 in accordance with some embodiments. The network environment 100 may include a UE 104 and a base station 108. The base station 108 may provide a serving cell (SC) 110 through which the UE 104 may communicate with the base station 108. In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The network environment 100 may further include one or more neighbor base stations that provide non-serving cells. For example, the network environment may include base station 116 that provides non-serving cell (NSC) 112. The base station 116 may use the same radio access technology as the base station 108 or a different radio access technology.

To adapt to changes in a radio environment and relative positioning between the UE 104 and the base stations, the UE 104 may be configured to perform a variety of measurements on reference signals transmitted in both the serving cell 110 and the non-serving cell 112. The base station 108 may transmit measurement configurations to provide the UE 104 with information to perform the reference signal measurements. Upon performing the measurements, the UE 104 may provide a measurement report to the base station 108. The base station 108 may perform various radio resource management (RRM) operations based on the measurement report.

The measurement configurations may instruct the UE 104 to perform measurements based on reference signals that include, for example, channel-state information—reference signals (CSI-RSs) and synchronization signal and physical broadcast channel blocks (SSBs). The measurements may be beam-level or cell-level.

The measurement configurations may be transmitted to the UE 104 while the UE 104 is in a radio resource control (RRC)-connected mode by dedicated signaling, such as RRC signaling (for example, an RRC reconfiguration message or RRC resume message).

In some embodiments, a measurement configuration may include (directly or by reference) a measurement identity, a measurement object, and a reporting configuration. The measurement identity may link a reporting configuration to a measurement object. The measurement identity may include a first pointer toward a reporting configuration and a second pointer toward a measurement object that provides information about the SSB resources that are to be measured. The UE 104 may provide measurement results within an RRC message (for example, an RRC measurement report) that includes the measurement ID as a reference.

The reporting configuration may provide a periodic, event-triggered, or cell global identity (CGI) configuration. The reporting configuration may include parameters, such as report amount, reporting interval, and, if the configuration is an event-triggered configuration, a measurement reporting event. The report amount and reporting interval may be abstract syntax notation one (ASN.1) fields in a report configuration information element (IE). The report amount may describe how many times a measurement report is to be transmitted based on a triggering event. The triggering event may be a period elapsing (for a periodic configuration) or a triggering condition of a measurement reporting event being satisfied (for an event-triggered configuration). The reporting interval may provide a time between successive transmissions of the measurement report. The reporting configuration may further describe the reference signal type (for example, SSB) that may be used for the periodic or event-triggered configurations.

The SSBs may be used for reference signal receive power (RSRP) measurements at Layer 1 (L1) or Layer 3 (L3). The L1 measurements may be used to monitor and respond to radio channel conditions on a shorter time frame as compared with L3 measurements. The L1 measurements may be used to, for example, perform beam management procedures, while the L3 measurements may be used to, for example, perform handover procedures.

In some embodiments, consistent with Release 17 3GPP TSs definition of further enhanced multiple-input, multiple-output (FeMIMO) in 3GPP TS 38.214 v17.2.0 (2022-06-23) and TS 38.331 v17.1.0 (2022-07-19), the UE 104 may be configured for L1-reference signal received power (RSRP) measurements on the NSC 112. The NSC 112 may have a different physical cell identity (PCI) than the PCI of the SC 110. In some embodiments, the NSC 112 may be referred to as a cell with different (or additional) PCI (CDP). The L1-RSRP measurements for the NSC 112 may provide the basis for inter-cell beam management. The serving base station 108 may use inter-cell beam management to instruct the UE 104 to switch from a beam associated with the SC 110 to a beam associated with the NSC 112 for receiving a physical downlink shared channel (PDSCH) or physical downlink control channel (PDCCH). This may be done with a simple transmission configuration indication (TCI) state switch without having to do a complete handover, which relies on layer 3 (L3) measurements and takes more time. Performing this dynamic beam switch may often be done when the UE 104 is operating in the higher frequency ranges, for example, frequency range 2 (FR2), from 24.25 GHz to 52.6 GHz, or above.

Performing L1-RSRP measurements on CDPs requires coordinated management of a number of measurement configurations. For example, SSB occasions from the serving cell 110 may overlap with SSB occasions from the NSC 112. Furthermore, the SSB occasions (from either SC 110 or NSC 112) may overlap with occasions from a measurement gap (MG) configuration (used for inter-frequency or inter-radio access technology (RAT) measurements) and occasions from SSB measurement timing configuration (SMTC) (used to define the measurement opportunities for performing the L3 measurements).

Embodiments describe how to determine sharing factors that may be used in FR2 and above to share measurement occasions between different measurements. The sharing factors may be determined for a variety of cases including, when the SMTC and MG fully or partially overlap with one another and both overlap with SSBs from the SC 110 or NSC 112, and the SSBs from the SC 110 or NSC 112 fully or partially overlap with one another. In another case, the SMTC and MG do not overlap, but overlap with SSBs from the SC 110 or NSC/CDP 112, and the SSBs from the SC 110 or NSC/CDP 112 fully or partially overlap with one another.

The UE 104 may use the sharing factor to determine which measurement occasions to use for a particular measurement. The network may use the sharing factor to determine an L1-RSRP measurement period. 3GPP TS 38.133 v17.6.0 (2022-06-30) defines the L1 measurement period, T_{L1-RSRP_Measurement_Period_SSB}, based on sharing factor (P). The L1 measurement period is a period in which a physical layer of the UE 104 is to determine L1-RSRP measurements with a sufficient accuracy. If the UE 104 does not report configured L1-RSRP measurements over the L1 measurement period, the base station 108 may determine there is a beam or radio-link failure and attempt to perform a radio resource management (RRM) operation such as configuring a new beam or cell.

In FR2, the L1 measurement period for the SC 110 may be determined as follows. Unless described elsewhere herein, the parameters used to calculate the L1 measurement period for the SC 110 may be similar to like-named parameters in clause 9.5.4.1 of 3GPP TS 38.133.

If the UE 104 is not operating in accordance with a discontinuous reception (DRX) configuration, the L1 measurement period may be equal to max(Tᵣₑₚₒᵣₜ, ceil (M*P*N)*T_{SSB}). Tᵣₑₚₒᵣₜ may be a configured periodicity for reporting, T_{SSB} may be the periodicity of an SSB index configured for L1-RSRP measurements of the SC 110, Mis equal to one if a time restriction for channel measurement parameter is configured or is equal to three otherwise, and N is eight.

If the UE 104 is operating in accordance with a DRX configuration not more than 320 milliseconds, the L1 measurement period may be equal to max(Tᵣₑₚₒᵣₜ, ceil (1.5*M*P*N)*max (T_{DRX}, T_{SSB}). T_{DRX} is a DRX cycle length and the rest of the parameters may be similar to those described above and in clause 9.5.4.1 of TS 38.133.

If the UE 104 is operating in accordance with a DRX configuration more than 320 milliseconds, the L1 measurement period may be equal to ceil (1.5*M*P*N)*T_{DRX}. The parameters may be similar to that described above and in clause 9.5.4.1 of TS 38.133.

In FR2, the L1 measurement period for the NSC 112 may be determined as follows. Unless described elsewhere herein, the parameters used to calculate the L1 measurement period for the NSC 112 may be similar to like-named parameters in clause 9.13.4 of 3GPP TS 38.133.

If the UE 104 is not operating in accordance with a discontinuous reception (DRX) configuration, the L1 measurement period may be equal to max(Tᵣₑₚₒᵣₜ, ceil (M*P*N)*T_{SSB,CDP}). Tᵣₑₚₒᵣₜ may be a configured periodicity for reporting, T_{SSB,CDP} may be the periodicity of an SSB index configured for the inter-cell L1-RSRP measurements of the NSC/CDP 112, M is equal to one if a time restriction for channel measurement parameter is configured or is equal to three otherwise, and N is eight.

If the UE 104 is operating in accordance with a DRX configuration not more than 320 milliseconds, the L1 measurement period may be equal to max(Tᵣₑₚₒᵣₜ, ceil (1.5*M*P*N)*max(T_{DRX}, T_{SSB,CDP}). T_{DRX} is a DRX cycle length.

If the UE 104 is operating in accordance with a DRX configuration more than 320 milliseconds, the L1 measurement period may be equal to ceil (1.5*M*P*N)*T_{DRX}.

Embodiments of the present disclosure describe how to determine the sharing factor (P), which may be used to determine the L1-RSRP measurement period for FR2 as described above, in a number of different scenarios.

In a first aspect of the disclosure, a periodicity relationship may be detected among at least two periodicities. The at least two periodicities may include periodicities associated with an SSB configuration of the SC 110 (referred to herein as T_{SSB,SC}), an SSB configuration of the NSC 112 (referred to herein as T_{SSB,CDP}), an MG configuration (referred to herein as MGRP), or the SMTC (referred to herein as T_{SMTC}). The periodicity relationship may be used as a basis to determine an intermediate sharing factor. An overlapping relationship may also be determined with respect to the SC SSB configuration and the SMTC or the MG configuration. A final sharing factor may then be determined based on the intermediate sharing factor and the overlapping relationship.

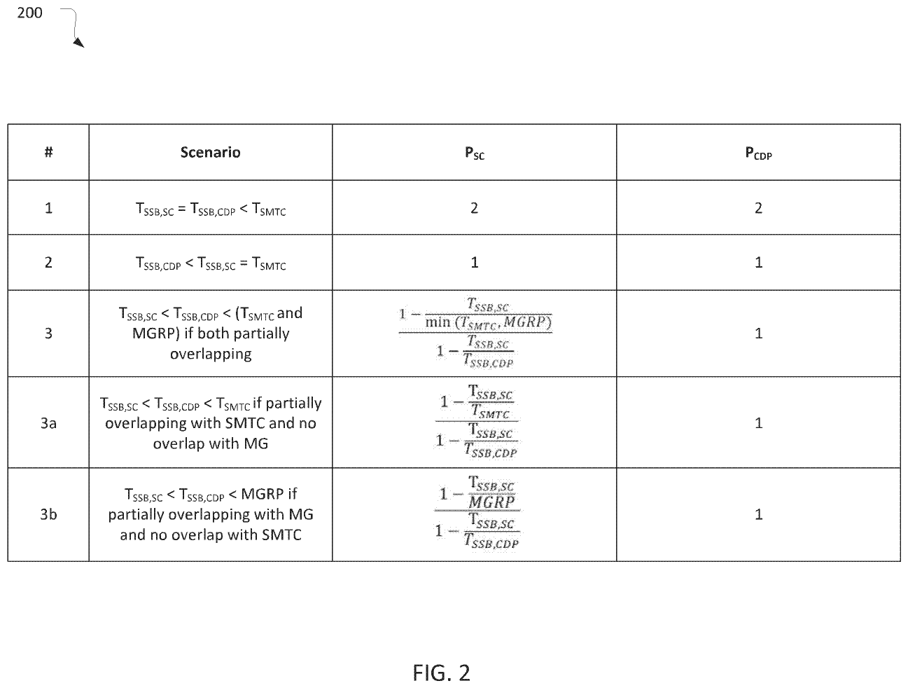

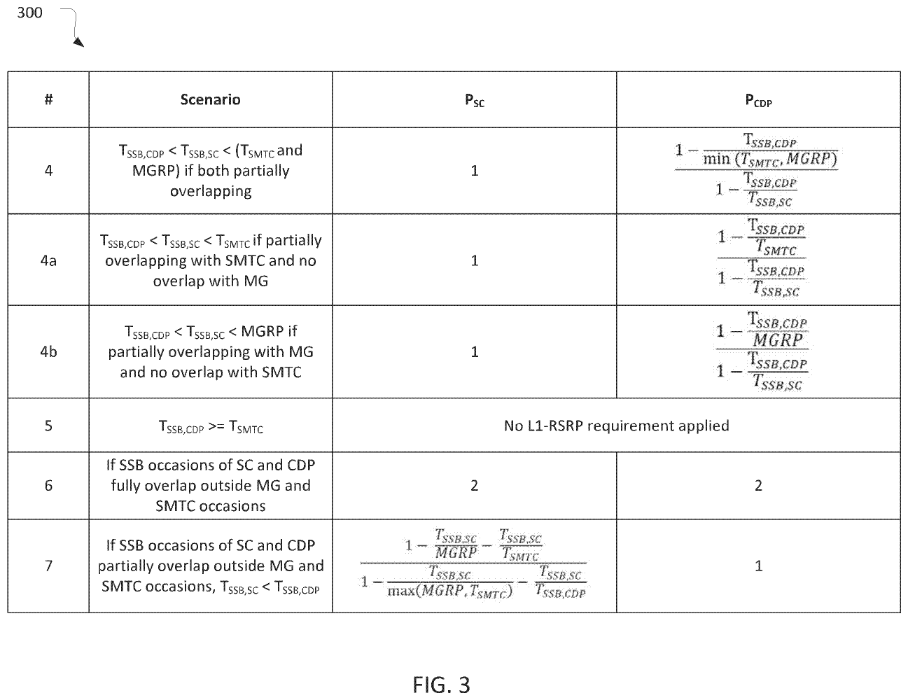

FIGS. 2 and 3 illustrate tables 200 and 300, respectively, for determining intermediate sharing factors based on periodicity relationships in accordance with some embodiments.

The table 200 may include an intermediate sharing factor P_{SC} for determining the sharing factor for the SC 110; and may include an intermediate sharing factor P_{CDP} for determining the sharing factor for the NSC 112.

In a first scenario, the periodicity relationship is defined by T_{SSB,SC}=T_{SSB,CDP}<T_{SMTC}. In this case, both the intermediate sharing factors P_{SC} and P_{CDP} may be set equal to two.

In a second scenario, the periodicity relationship is defined by T_{SSB,CDP}<T_{SSB,SC}=T_{SMTC}. In this case, both the intermediate sharing factors P_{SC} and P_{CDP} may be set equal to one.

In a third scenario, the periodicity relationship is defined by T_{SSB,SC}<T_{SSB,CDP}<(T_{SMTC} and MGRP). The third scenario may also be associated with the condition in which the target SSB configuration (e.g., the SC SSB configuration or the NSC SSB configuration, depending on which measurements are to be performed) partial overlaps with both the SMTC and MG configurations. A first configuration may be said to partially overlap with a second configuration if some occasions of the first configuration occur at the same time as occasions of the second configuration, while other occasions of the first configuration occur at different times than occasions of the second configuration.

For the third scenario, P_{SC} may be set equal to:

$$\frac{1 - \frac{{T}_{SSB , SC}}{min ( {T}_{SMTC} , MGRP )}}{1 - \frac{{T}_{SSB , SC}}{{T}_{SSB , CDP}}}$$

and P_{CDP} may be set equal to 1.

In a first option of the third scenario, referred to as scenario 3a, the periodicity relationship is defined by T_{SSB,SC} T_{SSB,CDP} T_{SMTC}. The 3a scenario may also be associated with the condition in which the target SSB configuration partially overlaps with the SMTC and does not overlap with the MG configuration.

For the 3a scenario, P_{SC} may be set equal to:

$$\frac{1 - \frac{{T}_{SSB , SC}}{{T}_{SMTC}}}{1 - \frac{{T}_{SSB , SC}}{{T}_{SSB , CDP}}}$$

and P_{CDP} may be set equal to 1.

In a second option of the third scenario, referred to as scenario 3b, the periodicity relationship is defined by T_{SSB,SC}<T_{SSB,CDP}<MGRP. The 3b scenario may also be associated with the condition in which the target SSB configuration partially overlaps with the MG configuration and does not overlap with the SMTC.

For the 3b scenario, P_{SC} may be set equal to:

$$\frac{1 - \frac{{T}_{SSB , SC}}{MGRP}}{1 - \frac{{T}_{SSB , SC}}{{T}_{SSB , CDP}}}$$

and P_{CDP} may be set equal to 1.

In a fourth scenario, the periodicity relationship is defined by T_{SSB,CDP}<T_{SSB,SC}<(T_{SMTC} and MGRP). The fourth scenario may also be associated with the condition in which the target SSB configuration partial overlaps with both the SMTC and MG configurations.

For the fourth scenario, P_{SC} may be set equal to 1 and P_{CDP} may be set equal to:

$$\frac{1 - \frac{{T}_{SSB , CDP}}{min ( {T}_{SMTC} , MGRP )}}{1 - \frac{{T}_{SSB , CDP}}{{T}_{SSB , SC}}} .$$

In a first option of the fourth scenario, referred to as scenario 4a, the periodicity relationship is defined by T_{SSB,CDP}<T_{SSB,SC}<T_{SMTC}. The 4a scenario may also be associated with the condition in which the target SSB configuration partially overlaps with the SMTC and does not overlap with the MG configuration.

For the 4a scenario, P_{SC} may be set equal to 1 and P_{CDP} may be set equal to:

$$\frac{1 - \frac{{T}_{SSB , CDP}}{{T}_{SMTC}}}{1 - \frac{{T}_{SSB , CDP}}{{T}_{SSB , SC}}} .$$

In a second option of the fourth scenario, referred to as scenario 4b, the periodicity relationship is defined by T_{SSB,CDP}<T_{SSB,SC}<MGRP. The 4b scenario may also be associated with the condition in which the target SSB configuration partially overlaps with the MG configuration and does not overlap with the SMTC.

For the 4b scenario, P_{SC} may be set equal to 1 and P_{CDP} may be set equal to:

$$\frac{1 - \frac{{T}_{SSB , CDP}}{MGRP}}{1 - \frac{{T}_{SSB , CDP}}{{T}_{SSB , SC}}} .$$

In a fifth scenario, the periodicity relationship is defined as T_{SSB,CDP} T_{SMTC}. In this scenario, no L1-RSRP requirement may be applied.

A sixth scenario may be associated with a condition in which SSB occasions of the SC and NSC fully overlap outside MG and SMTC occasions. In this case, both the intermediate sharing factors P_{SC} and P_{CDP} may be set equal to two.

In a seventh scenario, the periodicity relationship is defined as T_{SSB,SC}<T_{SSB,CDP}. The seventh scenario may also be associated with the condition in which SSB occasions of the SC SSB configuration and the NSC SSB configuration partially overlap one another and are outside the occasions of both the MG configuration and the SMTC.

In the seventh scenario, the P_{SC} may be set equal to

$$\frac{1 - \frac{{T}_{SSB , SC}}{MGRP} - \frac{{T}_{SSB , SC}}{{T}_{SMTC}}}{1 - \frac{{T}_{SSB , SC}}{max ( MGRP , {T}_{SMTC} )} - \frac{{T}_{SSB , SC}}{{T}_{SSB , CDP}}}$$

and the P_{CDP} may be set equal 1.

The intermediate sharing factor determined based on table 200 or 300 may be used to determine a final sharing factor as described below with respect to one of four cases.

In a first case, SSBs of a target SSB configuration may partially overlap with occasions of both the MG configuration and the SMTC, and the MG configuration may partially or fully overlap with the SMTC. In this case, the final sharing factor, P, may be provided by:

$$\frac{{P}_{ISF}}{1 - \frac{{T}_{SSB}}{min ( MGRP , {T}_{SMTC} )}} ,$$

where P_{ISF} is the intermediate sharing factor (P_{SC} or P_{CDP}) as given by Tables 200 or 300 discussed above. T_{SSB} may be the periodicity associated with the target SSB configuration.

In a second case, SSBs of the target SSB configuration partially overlap with occasions of both the MG configuration and the SMTC, and the MG configuration does not overlap with the SMTC. In this case, the final sharing factor, P, may be provided by:

$$\frac{{P}_{ISF}}{1 - \frac{{T}_{SSB}}{{T}_{SMTC}} - \frac{{T}_{SSB}}{MGRP}} .$$

In a third case, SSBs of the target SSB configuration partially overlap with occasions of the MG configuration, but do not overlap with occasions of the SMTC. In this case, the final sharing factor, P, may be provided by:

$$\frac{{P}_{ISF}}{1 - \frac{{T}_{SSB}}{MGRP}} .$$

In a fourth case, SSBs of the target SSB configuration partially overlap with occasions of the SMTC, but do not overlap with occasions of the MG configuration. In this case, the final sharing factor, P, may be provided by:

$$\frac{{P}_{ISF}}{1 - \frac{{T}_{SSB}}{{T}_{SMTC}}} .$$

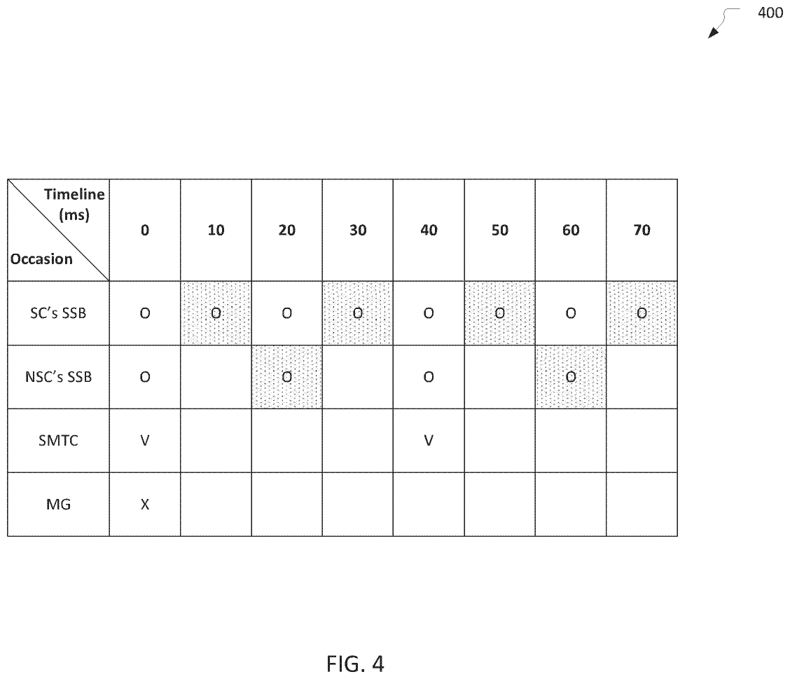

FIG. 4 illustrates example occasions 400 in accordance with some embodiments. The occasions 400 may include occasions from SC SSB configuration, an NSC SSB configuration, an MG configuration, and an SMTC. The occasions 400 represent an example of scenario 3 in which T_{SSB,SC} T_{SSB,CDP}<(T_{SMTC} and MGRP) and the SSB configurations partially overlap with the MG configuration and the SMTC, and the MG configuration and SMTC are partially or fully overlapped.

The SC SSB configuration may configure SC SSB occasions with a 10-ms periodicity and an offset of zero. The NSC SSB configuration may configure NSC SSB occasions with a 20-ms periodicity and an offset of zero. The SMTC may configure occasions with a 40-ms periodicity and an offset of zero. The MG configuration may configure MG occasions with a 80-ms periodicity an offset of zero.

In this case, both the MG occasions and the SMTC occasions partially overlap with the SC SSB occasions. Therefore, the P_{SC} may need to consider periodicities from both the MG (for example, the MGRP) and the SMTC (for example, the T_{SMTC}).

As the periodicity relationship of the occasions 400 corresponds to scenario 3 in FIG. 2, Pc may be found by:

$$\frac{1 - \frac{{T}_{SSB , SC}}{min ( {T}_{SMTC} , MGRP )}}{1 - \frac{{T}_{SSB , SC}}{{T}_{SSB , CDP}}} ,$$

which reduces to 3/2. This intermediate sharing factor may be used with the formula from the first case discussed above in which the target SSB configuration partially overlaps with SMTC and MG and MG and SMTC are partially or fully overlapped. In particular, the P_{SC} may be used to determine the final sharing factor, P, by:

$$P = \frac{{P}_{SC}}{1 - \frac{{T}_{SSB , SC}}{min ( MGRP , {T}_{SMTC} )}} ,$$

which reduces to 2.

A final sharing factor may mean that if a measurement needs x samples, the UE 104 may need P*x occasions in order to obtain those x samples. For example, with reference to FIG. 4, if the UE 104 needs four samples of the SC SSB, it may need 4*2 SC SSB occasions. The four samples obtained from the eight occasions are show in FIG. 4 with the dotted fill in the occasions at 10 ms, 30 ms, 50 ms, and 70 ms.

The intermediate sharing factor for the NSC 112, P_{CDP}, may be set to one for scenario 3 as shown by the Table 200. Using the same formula for the final sharing factor:

$$P = \frac{{P}_{CDP}}{1 - \frac{{T}_{SSB , CDP}}{min ( MGRP , {T}_{SMTC} )}} ,$$

which reduces to 2.

With reference to FIG. 4, if the UE 104 needs two samples of the NSC SSB, it may need 2*2 NSC SSB occasions. The two samples obtained from the four occasions are show in FIG. 4 with the dotted fill in the occasions at 20 ms and 60 ms.

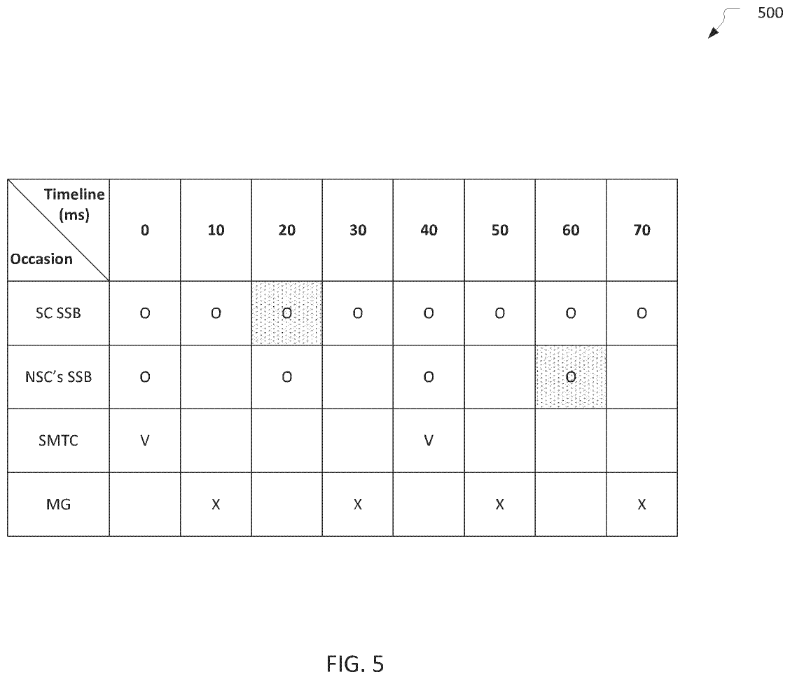

FIG. 5 illustrates example occasions 500 in accordance with some embodiments. The occasions 500 may include occasions from SC SSB configuration, an NSC SSB configuration, an MG configuration, and an SMTC. The occasions 500 represent an example in which the MG occasions do not overlap with the SMTC occasions or the NSC SSB occasions, but do partially overlap with the SC SSB occasions.

The SC SSB configuration may configure SC SSB occasions with a 10-ms periodicity and an offset of zero. The NSC SSB configuration may configure NSC SSB occasions with a 20-ms periodicity and an offset of zero. The SMTC may configure occasions with a 40-ms periodicity and an offset of zero. The MG configuration may configure MG occasions with a 10-ms offset and a 20-ms periodicity.

In this case, outside the SMTC occasions and MG occasions, the SC SSB occasions and the NSC SSB occasions are fully overlapped. This may correspond to scenario 6 of Table 300. Thus, the intermediate sharing factor for both the SC and the NSC is two, for example, P_{SC}=2 and P_{CDP}=2.

Since the SC SSB occasions overlap with both the MG occasions and the SMTC occasions, the intermediate sharing factors may be used with the formula from the second case discussed above in which the target SSB configuration partially overlaps with SMTC and MG, but the MG and SMTC do not overlap. In particular, the P_{SC} may be used to determine the final sharing factor, P, by:

$$P = \frac{{P}_{SC}}{1 - \frac{{T}_{SSB , SC}}{{T}_{SMTC}} - \frac{{T}_{SSB , SC}}{MGRP}} ,$$

Which reduces to 8.

With reference to FIG. 5, if the UE 104 needs one sample of the SC SSB, it may need 8*1 SC SSB occasions. The one sample obtained from the eight occasions is shown in FIG. 5 with the dotted fill in the SC SSB occasion at 20 ms.

Since the NSC SSB occasions only overlap with the SMTC occasions, the P_{CDP} may be used in the formula associated with the fourth case discussed above. In particular, the final sharing factor, P, may be determined by:

$$P = \frac{{P}_{CDP}}{1 - \frac{{T}_{SSB , CDP}}{{T}_{SMTC}}} ,$$

which reduces to 4.

With reference to FIG. 5, if the UE 104 needs one sample of the NSC SSB, it may need 1*4 NSC SSB occasions. The one sample obtained from the four occasions is show in FIG. 5 with the dotted fill in the NSC SSB occasion at 60 ms.

In some embodiments, instead of determining an intermediate sharing factor and using the intermediate sharing factor to calculate the final sharing factor, the final sharing factor may be derived directly based on counting of the number of available occasions.

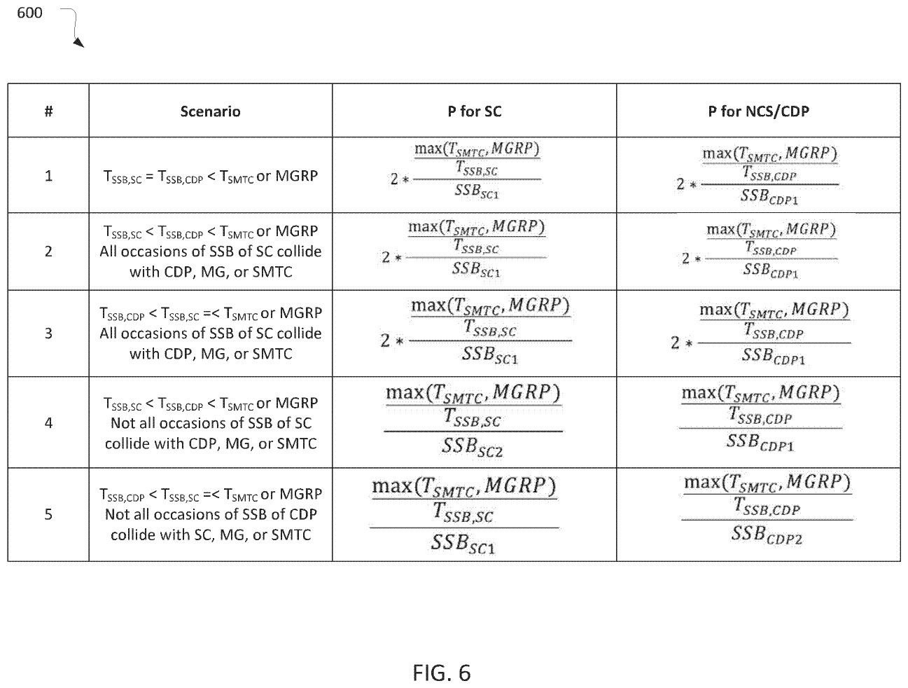

FIG. 6 illustrates a table 600 for directly determining a final sharing factor in accordance with some embodiments. The direct determination of the final sharing factor in table 600 may be based on one or more of the following four overlap numbers.

A first overlap number, SSB_{SC1}, is a number of SSB occasions of the SC 110 that overlap with SSB occasions of the NSC 112 but do not overlap with occasions of the MG configuration or SMTC within a time period equal to max(MGRP, T_{SMTC}).

A second overlap number, SSB_{CDP1}, is a number of SSB occasions of the NSC 112 that overlap with SSB occasions of the SC 110 but do not overlap with occasions of the MG configuration or SMTC within a time period equal to max(MGRP, T_{SMTC}).

A third overlap number, SSB_{SC2}, is a number of SSB occasions of the SC 110 that do not overlap with SSB occasions of the NSC 112, occasions of the MG configuration, or occasions of the SMTC within a time period equal to max(MGRP, T_{SMTC}).

A third overlap number, SSB_{CDP2}, is a number of SSB occasions of the NSC 112 that do not overlap with SSB occasions of the SC 110, occasions of the MG configuration, or occasions of the SMTC within a time period equal to max(MGRP, T_{SMTC}).

In a first scenario, the periodicity relationship is defined by T_{SSB,SC}=T_{SSB,CDP}<T_{SMTC} or MGRP. That is, both periodicities associated with the SC SSB configuration and the NSC SSB configuration are equal to one another, are less than the periodicity associated with SMTC, and are less than the periodicity associated with the MG configuration.

In the first scenario, the sharing factor, P, for the SC 110 may be given by:

$$2 * \frac{\frac{max ( {T}_{SMTC} , MGRP )}{{T}_{SSB , SC}}}{{SSB}_{SC 1}} ,$$

and the sharing factor, P, for the NSC 112 may be given by:

$$2 * \frac{\frac{max ( {T}_{SMTC} , MGRP )}{{T}_{SSB , CDP}}}{{SSB}_{CDP 1}} .$$

In a second scenario, the periodicity relationship is defined by T_{SSB,SC}<T_{SSB,CDP}<T_{SMTC} or MGRP. That is, the periodicity associated with SC SSB configuration is less than the periodicity associated with the NSC SSB configuration and the periodicity associated with the NSC SSB configuration is less than the periodicity associated with SMTC and is also less than the periodicity associated with the MG configuration. The second scenario may also be associated with the condition in which all the SC SSB occasions collide with NCS SSB occasions, occasions of the MG configuration, or occasions of the SMTC.

In the second scenario, the sharing factor, P, for the SC 110 may be given by:

$$2 * \frac{\frac{max ( {T}_{SMTC} , MGRP )}{{T}_{SSB , SC}}}{{SSB}_{SC 1}} ,$$

and the sharing factor, P, for the NSC 112 may be given by:

$$2 * \frac{\frac{max ( {T}_{S M T C} , MGRP )}{{T}_{SSB , CDP}}}{{SSB}_{CDP 1}} .$$

In a third scenario, the periodicity relationship is defined by T_{SSB,CDP}<T_{SSB,SC}<=T_{SMTC} or MGRP. That is, the periodicity associated with NSC SSB configuration is less than the periodicity associated with the SC SSB configuration and the periodicity associated with the SC SSB configuration is less than or equal to the periodicity associated with SMTC and is also less than or equal to the periodicity associated with the MG configuration. The third scenario may also be associated with the condition in which all the SC SSB occasions collide with NCS SSB occasions, occasions of the MG configuration, or occasions of the SMTC. In some embodiments, when determining the sharing factor for the NSC, the associated condition may be that all NSC SSB occasions collide with SC SSB occasions, occasions of the MG configuration, or occasions of the SMTC. However, given the relationship between the various occasions, these condition may effectively be the same.

In the third scenario, the sharing factor, P, for the SC 110 may be given by:

$$2 * \frac{\frac{max ( {T}_{SMTC} , MGRP )}{{T}_{SSB , SC}}}{SS {B}_{SC 1}} ,$$

and the sharing factor, P, for the NSC 112 may be given by:

$$2 * \frac{\frac{max ( {T}_{SMTC} , MGRP )}{{T}_{SSB , CDP}}}{{SSB}_{CDP 1}} .$$

In a fourth scenario, the periodicity relationship is defined by T_{SSB,SC}<T_{SSB,CDP}<T_{SMTC} or MGRP. That is, the periodicity associated with SC SSB configuration is less than the periodicity associated with the NSC SSB configuration and the periodicity associated with the NSC SSB configuration is less than the periodicity associated with SMTC and is also less than the periodicity associated with the MG configuration. The fourth scenario may also be associated with the condition in which not all the SC SSB occasions overlap with NCS SSB occasions, occasions of the MG configuration, or occasions of the SMTC. That is, at least some of the SC SSB occasions do not overlap with any other of the occasions.

In the fourth scenario, the sharing factor, P, for the SC 110 may be given by:

$$\frac{\frac{max ( {T}_{SMTC} , MGRP )}{{T}_{SSB , SC}}}{{SSB}_{SC 2}} ,$$

and the sharing factor, P, for the NSC 112 may be given by:

$$\frac{\frac{max ( {T}_{SMTC} , MGRP )}{{T}_{SSB , CDP}}}{{SSB}_{CDP 1}} .$$

In a fifth scenario, the periodicity relationship is defined by T_{SSB,CDP}<T_{SSB,SC}<T_{SMTC} or MGRP. That is, the periodicity associated with NSC SSB configuration is less than the periodicity associated with the SC SSB configuration and the periodicity associated with the SC SSB configuration is less than the periodicity associated with SMTC and is also less than the periodicity associated with the MG configuration. The fifth scenario may also be associated with the condition in which not all the NSC SSB occasions overlap with CS SSB occasions, occasions of the MG configuration, or occasions of the SMTC. That is, at least some of the NSC SSB occasions do not overlap with any other of the occasions.

In the fifth scenario, the sharing factor, P, for the SC 110 may be given by:

$$\frac{\frac{max ( {T}_{SMTC} , MGRP )}{{T}_{SSB , SC}}}{{SSB}_{SC 1}} ,$$

and the sharing factor, P, for the NSC 112 may be given by:

$$\frac{\frac{max ( {T}_{SMTC} , MGRP )}{{T}_{SSB , CDP}}}{{SSB}_{CDP 2}} .$$

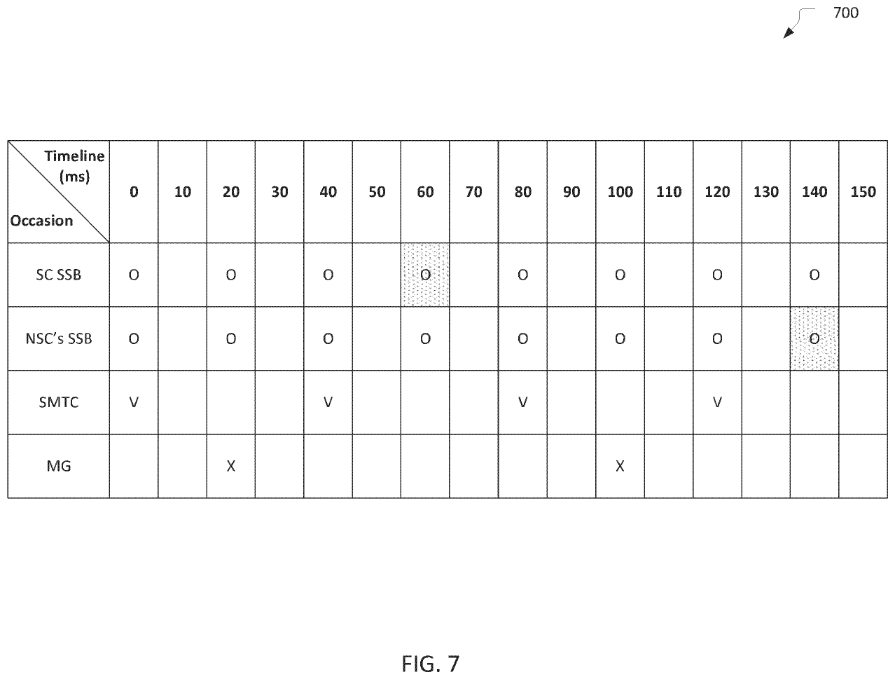

FIG. 7 illustrates example occasions 700 in accordance with some embodiments. The occasions 700 may include occasions from SC SSB configuration, an NSC SSB configuration, an MG configuration, and an SMTC. The occasions 700 represent an example of scenario 1 of FIG. 6 in which T_{SSB,SC}<T_{SSB,CDP}<T_{SMTC} or MGRP.

The SC SSB configuration may configure SC SSB occasions with a 20-ms periodicity and an offset of zero. The NSC SSB configuration may configure NSC SSB occasions with a 20-ms periodicity and an offset of zero. The SMTC may configure occasions with a 40-ms periodicity and an offset of zero. The MG configuration may configure MG occasions with a 80-ms periodicity an offset of 20 ms.

The first overlap number, SSB_{SC1}, is one as there is one instance (e.g., at 60 ms) in which the SSB occasions do not overlap with either occasions from the SMTC or the MG configuration in an 80 ms time period (e.g., equal to max(MGRP, T_{SMTC})). The sharing factor for the SC 110 may be determined by

$$2 * \frac{\frac{max ( {T}_{SMTC} , MGRP )}{{T}_{SSB , SC}}}{{SSB}_{SC 1}} ,$$

which reduces to 16/2/1=8.

With reference to FIG. 7, if the UE 104 needs one sample of the SC SSB, it may need 1*8 SC SSB occasions. The one sample obtained from the eight occasions is shown in FIG. 7 with the dotted fill in the occasion at 60 ms.

The third overlap number, SSB_{CDP1}, is one as there is one instance (e.g., at 60 ms) in which the SSB occasions do not overlap with either occasions from the SMTC or the MG configuration in an 80 ms time period (e.g., equal to max(MGRP, T_{SMTC})). The sharing factor for the NSC 110 may be determined by

$$2 * \frac{\frac{max ( {T}_{SMTC} , MGRP )}{{T}_{SSB , CDP}}}{{SSB}_{CDP 1}} ,$$

which reduces to 16/2/1=8.

With reference to FIG. 7, if the UE 104 needs one sample of the NSC SSB, it may need 1*8 NSC SSB occasions. The one sample obtained from the eight occasions is shown in FIG. 7 with the dotted fill in the occasion at 140 ms.

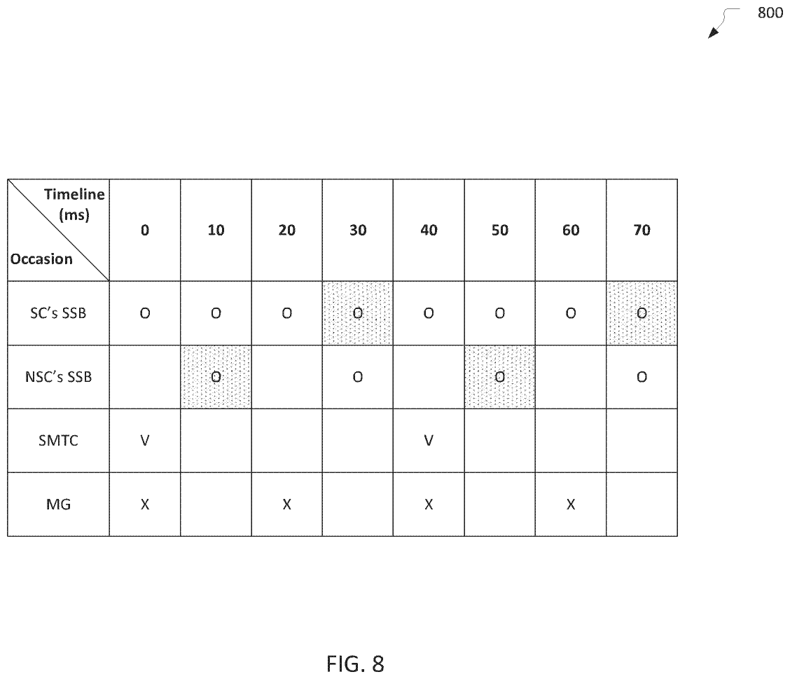

FIG. 8 illustrates example occasions 800 in accordance with some embodiments. The occasions 800 may include occasions from SC SSB configuration, an NSC SSB configuration, an MG configuration, and an SMTC. The occasions 800 represent an example of scenario 2 of FIG. 6 in which T_{SSB,SC}<T_{SSB,CDP}<T_{SMTC} or MGRP and all SC SSB occasions collide with NSC occasions, occasions of the MG configuration, or occasions of the SMTC.

The SC SSB configuration may configure SC SSB occasions with a 10-ms periodicity and an offset of zero. The NSC SSB configuration may configure NSC SSB occasions with a 20-ms periodicity and an offset of 10 ms. The SMTC may configure occasions with a 40-ms periodicity and an offset of zero. The MG configuration may configure MG occasions with a 20-ms periodicity an offset of zero.

The first overlap number, SSB_{SC1}, is two as there are two instances (e.g., at 10 ms and at 30 ms) in which the SSB occasions do not overlap with either occasions from the SMTC or the MG configuration in a 40 ms time period (e.g., equal to max(MGRP, T_{SMTC})). The sharing factor for the SC 110 may be determined by

$$2 * \frac{\frac{max ( {T}_{SMTC} , MGRP )}{{T}_{SSB , SC}}}{{SSB}_{SC 1}} ,$$

which reduces to 8/1/2=4.

With reference to FIG. 8, if the UE 104 needs two samples of the SC SSB, it may need 2*4 SC SSB occasions. The two samples obtained from the eight occasions are shown in FIG. 8 with the dotted fill in the occasions at 30 ms and 70 ms.

The second overlap number, SSB_{CDP1}, is two as there are two instances (e.g., at 10 ms and 30 ms) in which the SSB occasions do not overlap with either occasions from the SMTC or the MG configuration in a 80 ms time period (e.g., equal to max(MGRP, T_{SMTC})). The sharing factor for the NSC 110 may be determined by

$$2 * \frac{\frac{max ( {T}_{SMTC} , MGRP )}{{T}_{SSB , CDP}}}{{SSB}_{CDP 1}} ,$$

Which reduces to 8/2/2=2.

With reference to FIG. 8, if the UE 104 needs two samples of the NSC SSB, it may need 2*2 NSC SSB occasions. The two samples obtained from the four occasions are shown in FIG. 8 with the dotted fill in the occasions at 10 ms and 50 ms.

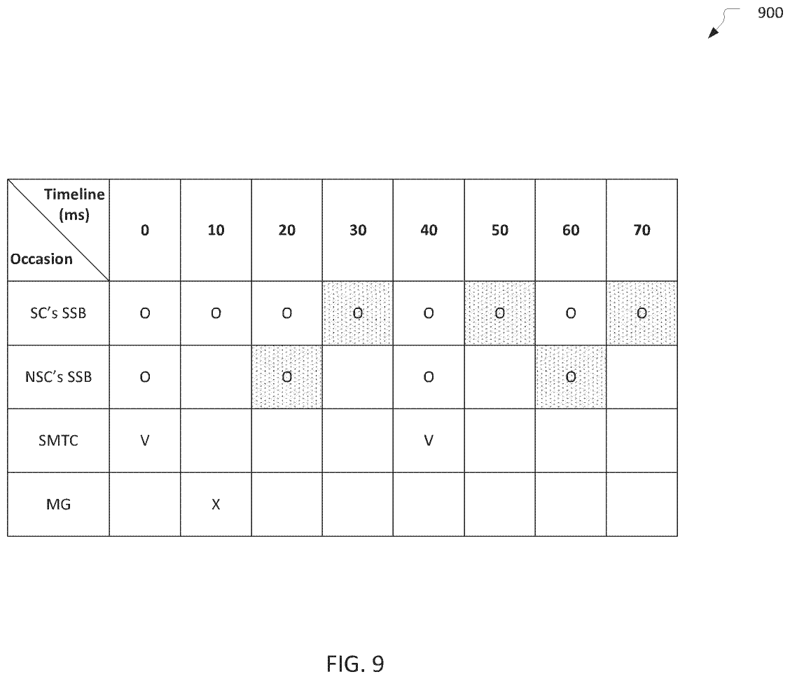

FIG. 9 illustrates example occasions 900 in accordance with some embodiments. The occasions 900 may include occasions from SC SSB configuration, an NSC SSB configuration, an MG configuration, and an SMTC. The occasions 900 represent an example of scenario 4 of FIG. 6 in which T_{SSB,SC}<T_{SSB,CDP}<T_{SMTC} or MGRP and not all SC SSB occasions collide with NSC SSB occasions, occasions of the MG configuration, or occasions of the SMTC.

The SC SSB configuration may configure SC SSB occasions with a 10-ms periodicity and an offset of zero. The NSC SSB configuration may configure NSC SSB occasions with a 20-ms periodicity and an offset of zero. The SMTC may configure occasions with a 40-ms periodicity and an offset of zero. The MG configuration may configure MG occasions with a 80-ms periodicity an offset of 10 ms.

The third overlap number, SSB_{SC2}, is three as there are three instances (e.g., at 30 ms, 50 ms, and 70 ms) in which the SC SSB occasions do not overlap with NSC SSB occasions, occasions of the SMTC, or occasions of the MG configuration in a 80 ms time period (e.g., equal to max(MGRP, T_{SMTC})). The sharing factor for the SC 110 may be determined by

$$\frac{\frac{max ( {T}_{S M T C} , MGRP )}{{T}_{SSB , SC}}}{{SSB}_{SC 2}} ,$$

which reduces to 8/1/3=8/3.

With reference to FIG. 9, if the UE 104 needs three samples of the SC SSB, it may need 3*(8/3) SC SSB occasions. The three samples obtained from the eight occasions are shown in FIG. 9 with the dotted fill in the occasions at 30 ms, 50 ms, and 70 ms.

The second overlap number, SSB_{CDP1}, is two as there are two instances (e.g., at 20 ms and 60 ms) in which the NSC SSB occasions overlap with the SC SSB occasions but do not overlap with either occasions from the SMTC or the MG configuration in a 80 ms time period (e.g., equal to max(MGRP, T_{SMTC})). The sharing factor for the NSC 110 may be determined by

$$\frac{\frac{max ( {T}_{S M T C} , MGRP )}{{T}_{SSB , CDP}}}{{SSB}_{CDP 1}} ,$$

which reduces to 8/2/2=2.

With reference to FIG. 9, if the UE 104 needs two samples of the NSC SSB, it may need 2*2 NSC SSB occasions. The two samples obtained from the four occasions are shown in FIG. 9 with the dotted fill in the occasions at 20 ms and 60 ms.

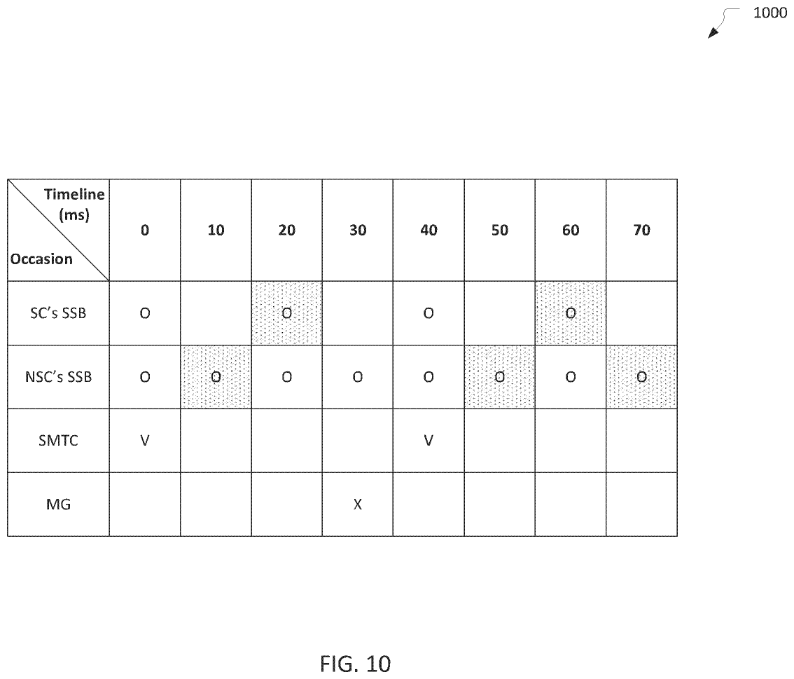

FIG. 10 illustrates example occasions 1000 in accordance with some embodiments. The occasions 1000 may include occasions from SC SSB configuration, an NSC SSB configuration, an MG configuration, and an SMTC. The occasions 1000 represent an example of scenario 5 of FIG. 6 in which T_{SSB,CDP}<T_{SSB,SC}<T_{SMTC} or MGRP and not all NSC SSB occasions overlap with SC SSB occasions, occasions of the MG configuration, or occasions of the SMTC.

The SC SSB configuration may configure SC SSB occasions with a 20-ms periodicity and an offset of zero. The NSC SSB configuration may configure NSC SSB occasions with a 10-ms periodicity and an offset of zero. The SMTC may configure occasions with a 40-ms periodicity and an offset of zero. The MG configuration may configure MG occasions with a 80-ms periodicity an offset of 30 ms.

The first overlap number, SSB_{SC1}, is two as there are two instances (e.g., at 20 ms and 60 ms) in which the SC SSB occasions overlap with NSC SSB occasions but do not overlap with occasions of the SMTC, or occasions of the MG configuration in a 80-ms time period (e.g., equal to max(MGRP, T_{SMTC})). The sharing factor for the SC 110 may be determined by

$$\frac{\frac{max ( {T}_{S M T C} , MGRP )}{{T}_{SSB , SC}}}{{SSB}_{SC 1}} ,$$

which reduces to 8/2/2=2.

With reference to FIG. 10, if the UE 104 needs two samples of the SC SSB, it may need 2*2 SC SSB occasions. The two samples obtained from the four occasions are shown in FIG. 10 with the dotted fill in the occasions at 20 ms and 60 ms.

The fourth overlap number, SSB_{CDP2}, is three as there are three instances (e.g., at 10 ms, 50 ms, and 70 ms) in which the NSC SSB occasions do not overlap with the SC SSB occasions, occasions from the SMTC, or occasions from the MG configuration in a 80 ms time period (e.g., equal to max(MGRP, T_{SMTC})). The sharing factor for the NSC 110 may be determined by

$$\frac{\frac{max ( {T}_{S M T C} , MGRP )}{{T}_{SSB , CDP}}}{{SSB}_{CDP 2}} ,$$

which reduces to 8/1/3=8/3.

With reference to FIG. 10, if the UE 104 needs three samples of the NSC SSB, it may need 3*(8/3) NSC SSB occasions. The three samples obtained from the eight occasions are shown in FIG. 10 with the dotted fill in the occasions at 10 ms, 50 ms, and 70 ms.

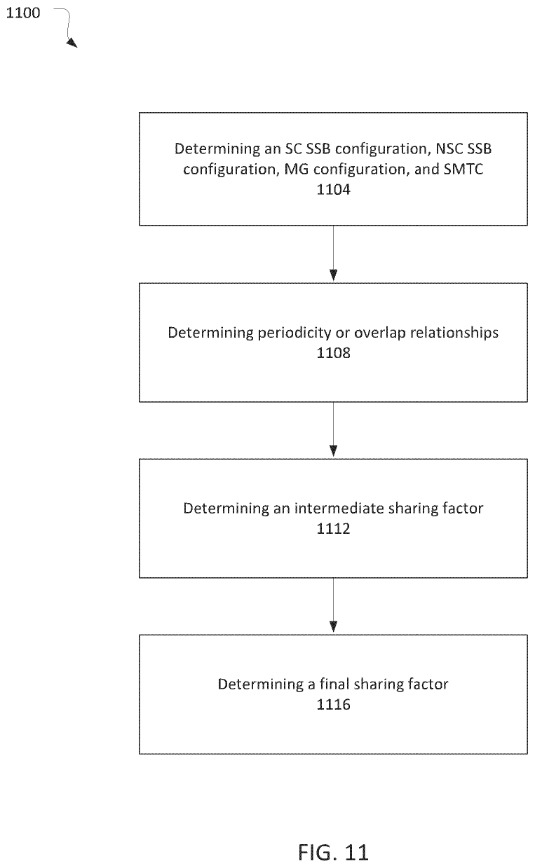

FIG. 11 illustrates an operation flow/algorithmic structure 1100 in accordance with some aspects. The operation flow/algorithmic structure 1100 may be performed or implemented by a UE, such as UE 104 or 1400; or components thereof; for example, baseband processor 1404A.

The operation flow/algorithmic structure 1100 may include, at 1104, determining an SC SSB configuration, an NSC SSB configuration, an MG configuration, and an SMTC. The configurations may be determined based on signaling from serving cell. Each of the configurations may include a periodicity and offset value.

The operation flow/algorithmic structure 1100 may further include, at 1108, determining periodicity and overlap relationships.

The periodicity relationship may be among at least two periodicities that include a first periodicity associated with the SC SSB configuration, a second periodicity associated with the NSC SSB configuration, a third periodicity of an SSB measurement timing configuration (SMTC), or a fourth periodicity of a measurement gap (MG) configuration. The periodicity relationship determined may be one of those referenced in any one of scenarios 1-7 of Tables 200 and 300.

The overlapping relationship may be with respect to a target SSB configuration and the SMTC or the MG configuration. The target SSB configuration may be the SC SSB configuration or the NSC SSB configuration.

The operation flow/algorithmic structure 1100 may further include, at 1112, determining an intermediate sharing factor. The intermediate sharing factor may be P_{SC} or P_{CDP} depending on whether the measurement to be performed is for an SC or NSC/CDP, respectively.

The intermediate sharing factor may be determined based on formulas associated with one of scenarios 1-7 of Tables 200 and 300. This may be based on the periodicity relationship determined at 1108. In some instances, the particular scenario may also be determined based on associated conditions as described above with respect to Tables 200 and 300.

With respect to scenarios 3-3b, the periodicity relationship may include SC SSB periodicity being less than the NSC SSB periodicity, and the NSC SSB periodicity being less than the SMTC periodicity or the MG periodicity. And the intermediate sharing factor may be one or based on a ratio of the SC SSB periodicity to the NSC SSB periodicity.

With respect to scenarios 4-4b, the periodicity relationship may include SC SSB periodicity being greater than the NSC SSB periodicity, and the SC SSB periodicity being less than the SMTC periodicity or the MG periodicity. And the intermediate sharing factor may be one or based on a ratio of the NSC SSB periodicity to the SC SSB periodicity.

With respect to scenario 6 and 7, a periodicity relationship may not necessarily be determined at 1108. Rather, a first overlap relationship may be determined based on which SSB occasions of the SC SSB configuration and SSB occasions of the NSC SSB configuration fully or partially overlap with one another outside of occasions of the MG configuration and occasions of the SMTC. The intermediate sharing factor may be determined based on the first overlap relationship. The intermediate sharing factor may be equal to one, two, or based on a ratio of the SC SSB periodicity to the NSC SSB periodicity.

A second overlap relationship with respect to the SC SSB configuration and the SMTC or the MG configuration.

The operation flow/algorithmic structure 1100 may further include, at 1116, determining a final sharing factor. The final sharing factor may be determined based on the intermediate sharing factor and the overlapping relationship determined at 1108 (the second overlapping relationship with respect to scenarios 6 and 7). In particular, the overlapping relationship determined at 1108 may be used to select one of the four cases described above for determining the final sharing factor based on the intermediate sharing factor.

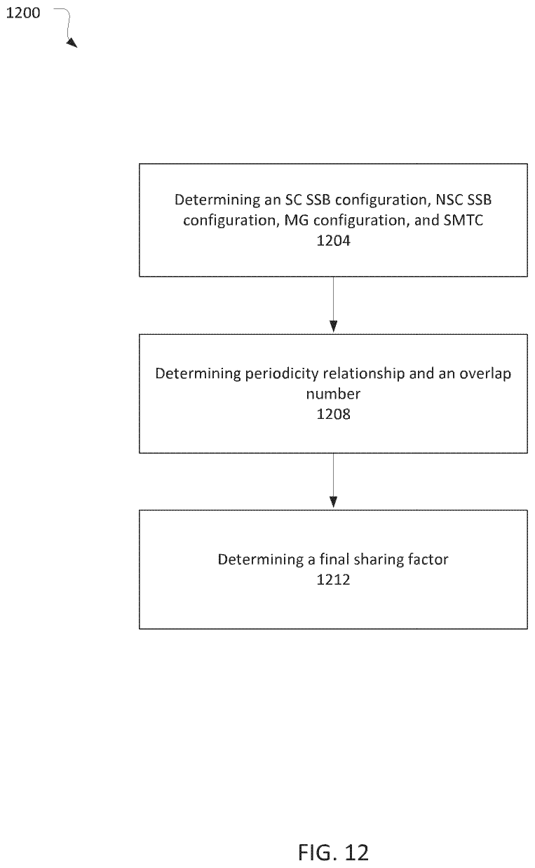

FIG. 12 illustrates an operation flow/algorithmic structure 1200 in accordance with some aspects. The operation flow/algorithmic structure 1200 may be performed or implemented by a UE, such as UE 104 or 1400; or components thereof, for example, baseband processor 1404A.

The operation flow/algorithmic structure 1200 may include, at 1204, determining an SC SSB configuration, an NSC SSB configuration, an MG configuration, and an SMTC. The configurations may be determined based on signaling from a serving cell. Each of the configurations may include a periodicity and offset value.

The operation flow/algorithmic structure 1200 may further include, at 1208, determining a periodicity relationship and an overlap number.

The periodicity relationship may be among at least two periodicities that include a first periodicity associated with the SC SSB configuration, a second periodicity associated with the NSC SSB configuration, a third periodicity of the SMTC, or a fourth periodicity of the MG configuration. The periodicity relationship determined may be one of those referenced in any one of scenarios 1-5 of Tables 600.

The overlap number may be determined with respect to a time period equal to max(MGRP, T_{SMTC}). The overlap number may correspond to SSB_{SC1}, SSB_{CDP1}, SSB_{SC2}, or SSB_{CDP2} discussed above with respect to FIG. 6.

The operation flow/algorithmic structure 1200 may further include, at 1212, determining a final sharing factor. The final sharing factor may be based on the periodicity relationship and the overlap number. In particular, the periodicity relationship may be used to select a scenario from Table 600 and the overlap number may be used in a corresponding formula from the selected scenario.

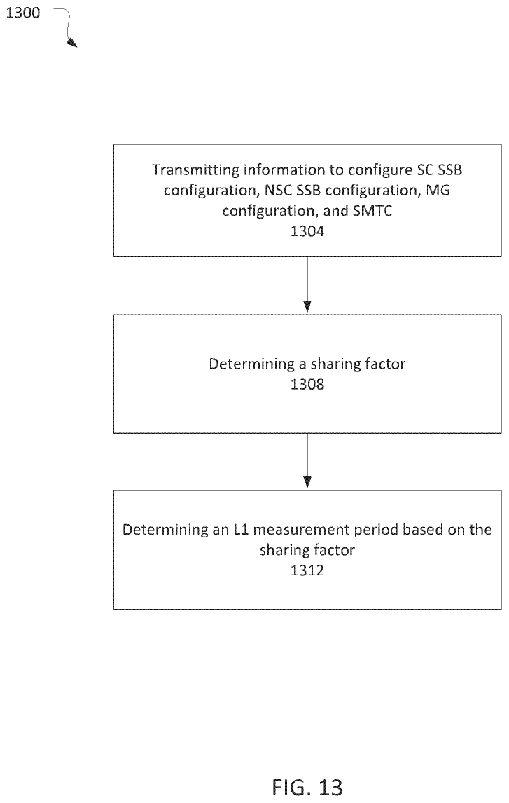

FIG. 13 illustrates an operation flow/algorithmic structure 1300 in accordance with some aspects. The operation flow/algorithmic structure 1300 may be performed or implemented by a serving base station, such as base station 108 or 1500, or components thereof; for example, baseband processor 1504A.

The operation flow/algorithmic structure 1300 may include, at 1304, transmitting information to configure SC/NSC SSB configurations, the MG configuration, and the SMTC.

The operation flow/algorithmic structure 1300 may further include, at 1308, determining a sharing factor. The sharing factor may be determined in a manner similar to that discussed elsewhere herein. For example, the base station may first determine an intermediate sharing factor and then determine a final sharing factor as described above with respect to Tables 200 and 300. Alternatively, the base station may derive the final sharing factor directly as described above with respect to Table 600.

The operation flow/algorithmic structure 1300 may further include, at 1312, determining an L1 measurement period based on the sharing factor. The base station may determine the L1 measurement period in a manner similar to that described elsewhere herein.

The base station may expect reporting of L1-RSRP measurements for the L1 measurement period. In the event that no measurements are received, the base station may assume there has been a link or beam failure and may proceed to perform link/beam recovery or reconfiguration operations.

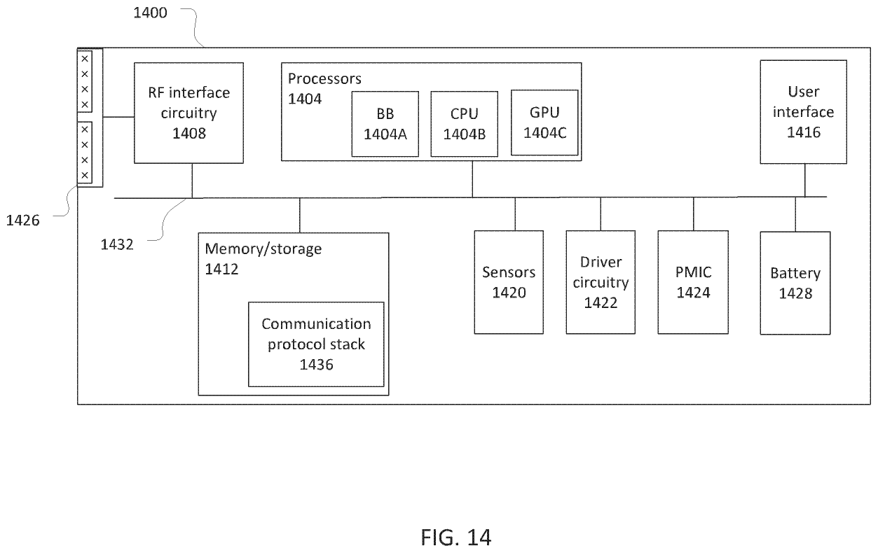

FIG. 14 illustrates a UE 1400 in accordance with some embodiments. The UE 1400 may be similar to and substantially interchangeable with UE 104 of FIG. 1.

The UE 1400 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various I/O devices that may be present within, or connected to, the UE 1400. For example, the driver circuitry 1412 may include circuitry to facilitate coupling of a UICC (for example, UICC 148) to the UE 1400. For additional examples, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400 including DRX as discussed herein.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

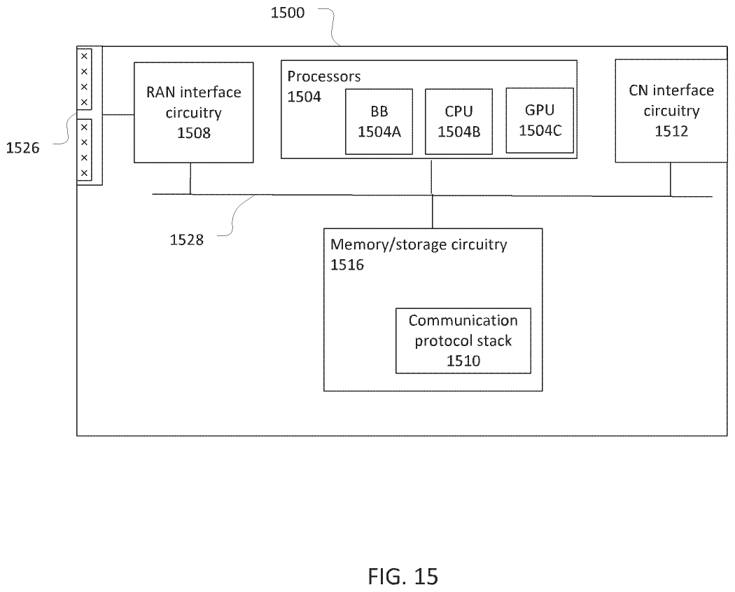

FIG. 15 illustrates a network node 1500 in accordance with some embodiments. The network node 1500 may be similar to and substantially interchangeable with base station 158.

The network node 1500 may include processors 1504, RF interface circuitry 1508 (if implemented as an access node), core network (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 9.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the network node 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

In some embodiments, the network node 1500 may be coupled with transmit receive points (TRPs) using the antenna structure 1526, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method comprising: determining a serving cell (SC) synchronization signal and physical broadcast channel block (SSB) configuration for Layer 1 (L1) measurements of an SC associated with a first physical cell identity (PCI); determining a non-serving cell (NCS) SSB configuration for L1 measurements of an NSC associated with a second PCI; comparing at least two periodicities, the at least two periodicities to include a first periodicity associated with the SC SSB configuration, a second periodicity associated with the NSC SSB configuration, a third periodicity of an SSB measurement timing configuration (SMTC), or a fourth periodicity of a measurement gap (MG) configuration; determining a overlap number with respect to a time period equal to max(MGRP, T_{SMTC}), where T_{SMTC} is the third periodicity and MGRP is the fourth periodicity; determining, based on the overlap number and said comparing the at least two periodicities, a sharing factor to identify measurement opportunities for a target SSB configuration; and performing measurements on the measurement opportunities for the target SSB configuration.

Example 2 includes a method of example 1 or some other example herein. The method of claim 1, wherein: said comparing comprises determining the first periodicity (T_{SSB,SC}) is equal to the second periodicity, is less than the third periodicity, and is less than the fourth periodicity; the target SSB configuration is the SC SSB configuration and the method further comprises determining the intermediate sharing factor is equal to: 2*

$$\frac{\frac{max ( {T}_{S M T C} , MGRP )}{{T}_{SSB , SC}}}{{SSB}_{SC 1}} ,$$

where SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

Example 3 includes method of example 1 or some other example herein, wherein: said comparing comprises determining the first periodicity is equal to the second periodicity (T_{SSB,CDP}), is less than the third periodicity, and is less than the fourth periodicity; the target SSB configuration is the NSC SSB configuration and the sharing factor is equal to:

$$2 * \frac{\frac{max ( {T}_{S M T C} M G R P )}{{T}_{SSB , CDP}}}{{SSB}_{CDP 1}} ,$$

where SSB_{CDP1} is the overlap number and is equal to a number of SSB occasions of the NSC SSB configuration that overlap with SSB occasions of the SC SSB configuration but do not overlap with any occasions of a set of occasions that include occasions of the MG configuration and occasions of the SMTC within the time period.

Example 4 includes a method of example 1 or some other example herein, wherein: said comparing comprises determining the first periodicity (T_{SSB,SC}) is less than the second periodicity (T_{SSB,CDP}), and determining the second periodicity is less than the third periodicity and is less than the fourth periodicity; the method further comprises determining all SSB occasions of the SC SSB configuration overlap with SSB occasions of the NSC SSB configuration, occasions of the MG configuration, or occasions of the SMTC; and the target SSB configuration is the SC SSB configuration and the sharing factor is equal to: 2*

$$\frac{\frac{max ( {T}_{S M T C} , MGRP )}{{T}_{SSB , SC}}}{{SSB}_{SC 1}} ,$$

where SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

Example 5 includes a method of example 1 or some other example herein, wherein: said comparing comprises: determining the first periodicity (T_{SSB,SC}) is less than the second periodicity (T_{SSB,CDP}), and determining the second periodicity is less than the third periodicity and is less than the fourth periodicity; the method further comprises determining all SSB occasions of the SC SSB configuration overlap with SSB occasions of the NSC SSB configuration, occasions of the MG configuration, or occasions of the SMTC; and the target SSB configuration is the NSC SSB configuration and the sharing factor is equal to: 2*

$$\frac{\frac{max ( {T}_{S M T C} , MGRP )}{{T}_{SSB , CDP}}}{{SSB}_{CDP 1}} ,$$

where SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

Example 6 includes a method of example 1 or some other example herein, wherein: said comparing comprises: determining the second periodicity (T_{SSB,CDP}) is less than the first periodicity (T_{SSB,SC}), and determining the first periodicity is less than or equal to the third periodicity, and is less than or equal to the fourth periodicity; the method further comprises determining all SSB occasions of the SC SSB configuration overlap with SSB occasions of the NSCS SB configuration, occasions of the MG configuration, or occasions of the SMTC; the target SSB configuration is the SC SSB configuration and the sharing factor is equal to:

$$2 * \frac{\frac{max ( {T}_{S M T C} , MGRP )}{{T}_{SSB , SC}}}{{SSB}_{SC 1}} ,$$

where SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

Example 7 includes the method of example 1 or some other example herein, wherein: said comparing comprises: determining the second periodicity (T_{SSB,CDP}) is less than the first periodicity (T_{SSB,SC}), and determining the second periodicity is less than or equal to the third periodicity, and is less than or equal to the fourth periodicity; the method further comprises determining all SSB occasions of the SC SSB configuration overlap with SSB occasions of the NSCS SB configuration, occasions of the MG configuration, or occasions of the SMTC; the target SSB configuration is the NSC SSB configuration and the sharing factor is equal to:

$$2 * \frac{\frac{max ( {T}_{S M T C} , MGRP )}{{T}_{SSB , CDP}}}{{SSB}_{CDP 1}} ,$$

where SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

Example 8 includes the method of example 1 or some other example herein, wherein: said comparing comprises: determining the first periodicity (T_{SSB,SC}) is less than the second periodicity (T_{SSB,CDP}), and determining the second periodicity is less than the third periodicity and is less than the fourth periodicity; the method further comprises determining at least some SSB occasions of the SC SSB configuration do not overlap with any occasions of a set of occasions that includes SSB occasions of the NSC SSB configuration, occasions of the MG configuration, and occasions of the SMTC; the target SSB configuration is the SC SSB configuration and the sharing factor is equal to:

$$\frac{\frac{max ( {T}_{S M T C} , MGRP )}{{T}_{SSB , SC}}}{{SSB}_{SC 2}} ,$$

where SSB_{SC2} is the overlap number and is equal to a number of SSB occasions of the SC SSB configuration that do not overlap with any occasions of the set of occasions within the time period.

Example 9 includes the method of example 1 or some other example herein, wherein: said comparing comprises: determining the first periodicity (T_{SSB,SC}) is less than the second periodicity (T_{SSB,CDP}), and determining the second periodicity is less than the third periodicity and is less than the fourth periodicity; the method further comprises determining at least some SSB occasions of the SC SSB configuration do not overlap with any occasions of a first set of occasions that includes SSB occasions of the NSC SSB configuration, occasions of the MG configuration, and occasions of the SMTC; the target SSB configuration is the NSC SSB configuration and the sharing factor is equal to:

$$\frac{\frac{max ( {T}_{S M T C} , MGRP )}{{T}_{SSB , CDP}}}{{SSB}_{CDP 1}} ,$$

where SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

Example 10 includes a method of example 1 or some other example herein, wherein: said comparing comprises: determining the second periodicity (T_{SSB,CDP}) is less than the first periodicity (T_{SSB,SC}), and determining the first periodicity is less than or equal to the third periodicity and is less than or equal to the fourth periodicity; the method further comprises determining at least some SSB occasions of the NSC SSB configuration do not overlap with any occasions from a first set of occasions that include SSB occasions of the SC SSB configuration, occasions of the MG configuration, and occasions of the SMTC; the target SSB configuration is the SC SSB configuration and the sharing factor is equal to:

$$\frac{\frac{max ( {T}_{S M T C} , MGRP )}{{T}_{SSB , SC}}}{{SSB}_{SC 1}} ,$$

where SSB_{SC1} is the overlap number and is equal to a number of SSB occasions of the SC SSB configuration that overlap with SSB occasions of the NSC SSB configuration but do not overlap with any occasions from a second set of occasions that include occasions of the MG configuration and occasions of the SMTC within the time period all equal to max(MGRP, T_{SMTC}).

Example 11 includes a method of example 1 or some other example herein, wherein: said comparing comprises: determining the second periodicity (T_{SSB,CDP}) is less than the first periodicity (T_{SSB,SC}), and determining the first periodicity is less than or equal to the third periodicity and is less than or equal to the fourth periodicity; the method further comprises determining at least some SSB occasions of the NSC SSB configuration do not overlap with any occasions from a set of occasions that include SSB occasions of the SC SSB configuration, occasions of the MG configuration, and occasions of the SMTC; the target SSB configuration is the NSC SSB configuration and the sharing factor is equal to:

$$\frac{\frac{max ( {T}_{S M T C} , MGRP )}{{T}_{SSB , CDP}}}{{SSB}_{CDP 2}} ,$$

where SSB_{CDP2} is the overlap number and is equal to a number of SSB occasions of the NSC SSB configuration that do not overlap with any occasions from the set of occasions within the time period.

Example 12 includes a method of operating a base station, the method comprising: transmitting information to a user equipment (UE) to configure a serving cell (SC) synchronization signal and physical broadcast channel block (SSB) configuration for Layer 1 (L1) measurements of an SC associated with a first physical cell identity (PCI), configured a non-serving cell (NSC) SSB configuration for L1 measurements of an NSC associated with a second PCI, a measurement gap (MG) configuration, and an SSB measurement timing configuration (SMTC); comparing at least two periodicities, the at least two periodicities to include a first periodicity associated with the SC SSB configuration, a second periodicity associated with the NSC SSB configuration, a third periodicity of the SMTC, or a fourth periodicity of the MG configuration; determining an overlap number with respect to a time period equal to max(MGRP, T_{SMTC}), where T_{SMTC} is the third periodicity and MGRP is the fourth periodicity; determining, based on the overlap number and said comparing the at least two periodicities, a sharing factor to identify measurement opportunities for a target SSB configuration.

Example 13 includes the method of example 19 or some other example herein, further comprising: determining an L1 measurement period based on the sharing factor.

Example 14 may include an apparatus comprising means to perform one or more elements of a method described in or related to any of examples 1-13, or any other method or process described herein.

Example 15 may include one or more non-transitory computer-readable media comprising instructions to cause an electronic device, upon execution of the instructions by one or more processors of the electronic device, to perform one or more elements of a method described in or related to any of examples 1-13, or any other method or process described herein.

Example 16 may include an apparatus comprising logic, modules, or circuitry to perform one or more elements of a method described in or related to any of examples 1-13, or any other method or process described herein.

Example 17 may include a method, technique, or process as described in or related to any of examples 1-13, or portions or parts thereof.

Example 18 may include an apparatus comprising: one or more processors and one or more computer-readable media comprising instructions that, when executed by the one or more processors, cause the one or more processors to perform the method, techniques, or process as described in or related to any of examples 1-13, or portions thereof.

Example 19 may include a signal as described in or related to any of examples 1-13, or portions or parts thereof.

Example 20 may include a datagram, information element, packet, frame, segment, PDU, or message as described in or related to any of examples 1-13, or portions or parts thereof, or otherwise described in the present disclosure.

Example 21 may include a signal encoded with data as described in or related to any of examples 1-13, or portions or parts thereof, or otherwise described in the present disclosure.

Example 22 may include a signal encoded with a datagram, IE, packet, frame, segment, PDU, or message as described in or related to any of examples 1-13, or portions or parts thereof, or otherwise described in the present disclosure.

Example 23 may include an electromagnetic signal carrying computer-readable instructions, wherein execution of the computer-readable instructions by one or more processors is to cause the one or more processors to perform the method, techniques, or process as described in or related to any of examples 1-13, or portions thereof.

Example 24 may include a computer program comprising instructions, wherein execution of the program by a processing element is to cause the processing element to carry out the method, techniques, or process as described in or related to any of examples 1-13, or portions thereof.

Example 25 may include a signal in a wireless network as shown and described herein.

Example 26 may include a method of communicating in a wireless network as shown and described herein.

Example 27 may include a system for providing wireless communication as shown and described herein.

Example 28 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
determining a serving cell (SC) synchronization signal and physical broadcast channel block (SSB) configuration for Layer 1 (L1) measurements of an SC associated with a first physical cell identity (PCI);
determining a non-serving cell (NCS) SSB configuration for L1 measurements of an NSC associated with a second PCI;
comparing at least two periodicities, the at least two periodicities to include a first periodicity associated with the SC SSB configuration, a second periodicity associated with the NSC SSB configuration, a third periodicity of an SSB measurement timing configuration (SMTC), or a fourth periodicity of a measurement gap (MG) configuration;
determining a overlap number with respect to a time period equal to max(MGRP, T_{SMTC}), where T_{SMTC} is the third periodicity and MGRP is the fourth periodicity;
determining, based on the overlap number and said comparing the at least two periodicities, a sharing factor to identify measurement opportunities for a target SSB configuration; and
performing measurements on the measurement opportunities for the target SSB configuration.

22. The method of claim 21, wherein:
said comparing comprises determining the first periodicity is equal to the second periodicity, is less than the third periodicity, and is less than the fourth periodicity; and
the target SSB configuration is the SC SSB configuration and the method further comprises determining the sharing factor is equal to:
$$2 ⋆ \frac{\frac{max ( {T}_{S M T C} , MGRP )}{{T}_{SSB , SC}}}{{SSB}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

23. The method of claim 21, wherein:
said comparing comprises determining the first periodicity is equal to the second periodicity, is less than the third periodicity, and is less than the fourth periodicity; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions of a set of occasions that include occasions of the MG configuration and occasions of the SMTC within the time period.

24. The method of claim 21, wherein:
said comparing comprises determining the first periodicity is less than the second periodicity, and determining the second periodicity is less than the third periodicity and is less than the fourth periodicity;
the method further comprises determining all SSB occasions of the SC SSB configuration overlap with SSB occasions of the NSC SSB configuration, occasions of the MG configuration, or occasions of the SMTC; and
the target SSB configuration is the SC SSB configuration and the sharing factor is equal to:
$$2 * \frac{\frac{max ( {T}_{SMTC} , MGRP )}{{T}_{SSB , SC}}}{SS {B}_{SC 1}} ,$$
where T_{SSB,CDP} is the second periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

25. The method of claim 21, wherein:
said comparing comprises: determining the first periodicity is less than the second periodicity, and determining the second periodicity is less than the third periodicity and is less than the fourth periodicity;
the method further comprises determining all SSB occasions of the SC SSB configuration overlap with SSB occasions of the NSC SSB configuration, occasions of the MG configuration, or occasions of the SMTC; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

26. The method of claim 21, wherein:
said comparing comprises: determining the second periodicity (T_{SSB,CDP}) is less than the first periodicity (T_{SSB,SC}), and determining the first periodicity is less than or equal to the third periodicity, and is less than or equal to the fourth periodicity;
the method further comprises determining all SSB occasions of the SC SSB configuration overlap with SSB occasions of the NSC SSB configuration, occasions of the MG configuration, or occasions of the SMTC; and
the target SSB configuration is the SC SSB configuration and the sharing factor is equal to:
$$2 * \frac{\frac{max ( {T}_{SMTC} , MGRP )}{{T}_{SSB , SC}}}{SS {B}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

27. The method of claim 21, wherein:
said comparing comprises: determining the second periodicity is less than the first periodicity, and determining the second periodicity is less than or equal to the third periodicity, and is less than or equal to the fourth periodicity;
the method further comprises determining all SSB occasions of the SC SSB configuration overlap with SSB occasions of the NSC SSB configuration, occasions of the MG configuration, or occasions of the SMTC; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

28. The method of claim 21, wherein:
said comparing comprises: determining the first periodicity is less than the second periodicity, and determining the second periodicity is less than the third periodicity and is less than the fourth periodicity;
the method further comprises determining at least some SSB occasions of the SC SSB configuration do not overlap with any occasions of a set of occasions that includes SSB occasions of the NSC SSB configuration, occasions of the MG configuration, and occasions of the SMTC; and
the target SSB configuration is the SC SSB configuration and the sharing factor is equal to:
$$\frac{\frac{max ( {T}_{SMTC} , MGRP )}{{T}_{SSB , SC}}}{{SSB}_{SC 2}} ,$$
where T_{SSB,SC} is the first periodicity, SSB_{SC2} is the overlap number and is equal to a number of SSB occasions of the SC SSB configuration that do not overlap with any occasions of the set of occasions within the time period.

29. The method of claim 21, wherein:
said comparing comprises: determining the first periodicity is less than the second periodicity, and determining the second periodicity is less than the third periodicity and is less than the fourth periodicity;
the method further comprises determining at least some SSB occasions of the SC SSB configuration do not overlap with any occasions of a first set of occasions that includes SSB occasions of the NSC SSB configuration, occasions of the MG configuration, and occasions of the SMTC; and
the target SSB configuration is the NSC SSB configuration and the sharing factor is equal to:
$$\frac{\frac{max ( {T}_{S M T C} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

30. The method of claim 21, wherein:
said comparing comprises: determining the second periodicity is less than the first periodicity, and determining the first periodicity is less than or equal to the third periodicity and is less than or equal to the fourth periodicity;
the method further comprises determining at least some SSB occasions of the NSC SSB configuration do not overlap with any occasions from a first set of occasions that include SSB occasions of the SC SSB configuration, occasions of the MG configuration, and occasions of the SMTC; and
the target SSB configuration is the SC SSB configuration and the sharing factor is equal to:
$$\frac{\frac{max ( {T}_{SMTC} , MGRP )}{{T}_{SSB , SC}}}{{SSB}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a second set of occasions that include occasions of the MG configuration and occasions of the SMTC within the time period all equal to max(MGRP, T_{SMTC}).

31. The method of claim 21, wherein:
said comparing comprises: determining the second periodicity is less than the first periodicity, and determining the first periodicity is less than or equal to the third periodicity and is less than or equal to the fourth periodicity;
the method further comprises determining at least some SSB occasions of the NSC SSB configuration do not overlap with any occasions from a set of occasions that include SSB occasions of the SC SSB configuration, occasions of the MG configuration, and occasions of the SMTC; and
the target SSB configuration is the NSC SSB configuration and the sharing factor is equal to:
$$\frac{\frac{max ( {T}_{SMTC} , MGRP )}{{T}_{SSB , CDP}}}{{SSB}_{CDP 2}} ,$$
where T_{SSB,CDP} is the second periodicity, SSB_{CDP2} is the overlap number and is equal to a number of SSB occasions of the NSC SSB configuration that do not overlap with any occasions from the set of occasions within the time period.

32. One or more non-transitory, computer-readable media (NTCRM) having instructions that, when executed, cause processor circuitry to:
determine a serving cell (SC) synchronization signal and physical broadcast channel block (SSB) configuration for Layer 1 (L1) measurements of an SC associated with a first physical cell identity (PCI);
determine a non-serving cell (NCS) SSB configuration for L1 measurements of an NSC associated with a second PCI;
compare at least two periodicities, the at least two periodicities to include a first periodicity associated with the SC SSB configuration, a second periodicity associated with the NSC SSB configuration, a third periodicity of an SSB measurement timing configuration (SMTC), or a fourth periodicity of a measurement gap (MG) configuration;
determine an overlap number with respect to a time period equal to max(MGRP, T_{SMTC}), where T_{SMTC} is the third periodicity and MGRP is the fourth periodicity;
determine, based on the overlap number and said comparison of the at least two periodicities, a sharing factor to identify measurement opportunities for a target SSB configuration; and
perform measurements on the measurement opportunities for the target SSB configuration.

33. The one or more NTCRM of claim 32, wherein:
comparison of the at least two periodicities comprises determine the first periodicity is equal to the second periodicity, is less than the third periodicity, and is less than the fourth periodicity; and
the target SSB configuration is the SC SSB configuration and the instructions, when executed, further cause the processor circuitry to determine the sharing factor is equal to:
$$2 * \frac{\frac{max ( {T}_{SMTC} , MGRP )}{{T}_{SSB , SC}}}{{SSB}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

34. The one or more NTCRM of claim 32, wherein:
comparison of the at least two periodicities comprises determine the first periodicity is equal to the second periodicity, is less than the third periodicity, and is less than the fourth periodicity; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions of a set of occasions that include occasions of the MG configuration and occasions of the SMTC within the time period.

35. The one or more NTCRM of claim 32, wherein:
comparison of the at least two periodicities comprises determine the first periodicity is less than the second periodicity, and determine the second periodicity is less than the third periodicity and is less than the fourth periodicity;
the instructions, when executed, further cause the processor circuitry to determine all SSB occasions of the SC SSB configuration overlap with SSB occasions of the NSC SSB configuration, occasions of the MG configuration, or occasions of the SMTC; and
the target SSB configuration is the SC SSB configuration and the sharing factor is equal to:
$$2 * \frac{\frac{max ( {T}_{SMTC} , MGRP )}{{T}_{SSB , SC}}}{{SSB}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

36. The one or more NTCRM of claim 32, wherein:
comparison of the at least two periodicities comprises determine the first periodicity is less than the second periodicity, and determine the second periodicity is less than the third periodicity and is less than the fourth periodicity;
the instructions, when executed, further cause the processor circuitry to determine all SSB occasions of the SC SSB configuration overlap with SSB occasions of the NSC SSB configuration, occasions of the MG configuration, or occasions of the SMTC; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

37. The one or more NTCRM of claim 32, wherein:
comparison of the at least two periodicities comprises determine the second periodicity is less than the first periodicity, and determine the first periodicity is less than or equal to the third periodicity, and is less than or equal to the fourth periodicity;
the instructions, when executed, further cause the processor circuitry to determine all SSB occasions of the SC SSB configuration overlap with SSB occasions of the NSC SSB configuration, occasions of the MG configuration, or occasions of the SMTC; and
the target SSB configuration is the SC SSB configuration and the sharing factor is equal to:
$$2 * \frac{\frac{max ( {T}_{SMTC} , MGRP )}{{T}_{SSB , SC}}}{{SSB}_{SC 1}} ,$$
where T_{SSB,SC} is the first periodicity, SSB_{SC1} is the overlap number and is equal to a number of SSB occasions of the SC SSB configuration that overlap with SSB occasions of the NSC SSB configuration but do not overlap with any occasions from a set of occasions that include occasions of the MG configuration and occasions of the SMTC within the time period.

38. The one or more NTCRM of claim 32, wherein:
comparison of the at least two periodicities comprises determine the second periodicity is less than the first periodicity, and determine the second periodicity is less than or equal to the third periodicity, and is less than or equal to the fourth periodicity;
the instructions, when executed, further cause the processor circuitry to determine all SSB occasions of the SC SSB configuration overlap with SSB occasions of the NSC SSB configuration, occasions of the MG configuration, or occasions of the SMTC; and
the target SSB configuration is the NSC SSB configuration and the sharing factor is equal to:
$$2 * \frac{\frac{max ( {T}_{SMTC} , MGRP )}{{T}_{SSB , CDP}}}{{SSB}_{CDP 1}} ,$$
where T_{SSB,CDP} is the second periodicity, SSB_{CDP1} is the overlap number and is equal to a number of SSB occasions of the NSC SSB configuration that overlap with SSB occasions of the SC SSB configuration but do not overlap with any occasions from a set of occasions that include occasions of the MG configuration and occasions of the SMTC within the time period.

39. A method comprising:
generating information to be transmitted to a user equipment (UE), the information to configure a serving cell (SC) synchronization signal and physical broadcast channel block (SSB) configuration for Layer 1 (L1) measurements of an SC associated with a first physical cell identity (PCI), configured a non-serving cell (NSC) SSB configuration for L1 measurements of an NSC associated with a second PCI, a measurement gap (MG) configuration, and an SSB measurement timing configuration (SMTC);
comparing at least two periodicities, the at least two periodicities to include a first periodicity associated with the SC SSB configuration, a second periodicity associated with the NSC SSB configuration, a third periodicity of the SMTC, or a fourth periodicity of the MG configuration;
determining an overlap number with respect to a time period equal to max(MGRP, T_{SMTC}), where T_{SMTC} is the third periodicity and MGRP is the fourth periodicity;
determining, based on the overlap number and said comparing the at least two periodicities, a sharing factor to identify measurement opportunities for a target SSB configuration.

40. The method of claim 39, further comprising:
determining an L1 measurement period based on the sharing factor.
